(19) United States
(12) Patent Application Publication
(10) Pub. No.: US 2012/0274083 A1
(43) Pub. Date: Nov. 1, 2012

(54) Hexalobular, or star, control means

(76) Inventor: Edward O'Hanlon, Tucson, AZ (US)

(21) Appl. No.: 13/066,902

(22) Filed: Apr. 28, 2011

(51) Int. Cl. E05C 1/08

(52) U.S. Cl. 292/155

(57) ABSTRACT

A locking and control device consisting of a hexalobular, or star security headed machine screw, which screw can be modified for security reasons by closing off the star interstices and removing its corresponding screwdriver lobes such that when the machine screw head is inserted into a hole drilled through a door or door frame, being part of a doorway, and secured there by means of a base mounting plate screwed to the inside of the door, or door frame, the machine screw head can be accessed through the said hole by means of a corresponding screwdriver such that when the machine screw head is turned by the screw-driver so also will the lock bolt, or some other means to be controlled such as a slide plate or electrical switch attached to the machine screw end be turned thus locking or unlocking the door or operating the other said devices.

### THE BACKGROUND OF THE INVENTION

The advent of the readily obtainable master key, which can open any cylinder lock, and which key is known as a ‘bump key’, fully compromised the security aspect of the universally used dead bolt lock. Anyone using a ‘bump key’ can now open any door employing these said cylinder locks.

Since the integrity of the cylinder lock used in most homes as their prime security device has been compromised the following enclosed invention described herein is proposed as an alternative to the compromised cylinder lock.

A hexalobular headed machine screw with its many differing sizes and its additional security configurations in addition to a further means of coding the screw head and with the only external manifestation of its existence being a small hole in the outside of the door or frame which can be placed anywhere along the height of the door or frame offers one of the best means of replacing the cylinder lock as a prime controller for dead locks.

The hexalobular machine screw controlled lock, or any other such device which can be so controlled such as an alarm system or security camera, has many different attachments to the machine screw to perform the many differing functions herein enumerated. The lock application of the hexalobular machine screw control consists of a rectangular lock bolt attached to the threaded end of the machine screw subsequent to the screw being inserted through a clearance hole in a base mounting plate and a metal spacer such that the hexalobular machine screw is held firmly at right angles to the base plate, in a manner that the hexalobular head is distal to the base plate.

The hexalobular head then inserted into a large diameter hole drilled through three quarters of the thickness of the door such that the hexalobular head can be accessed through a smaller hole drilled on the outside of the door which hole is concentric to the larger diameter hole by means of a suitable hexalobular modified screwdriver herein defined as a key.

Upon turning the hexalobular head of the machine screw the attached rectangular lock bolt so also turns such that it crosses the gap between the door and the door frame and hence into a hooked strike attached to the door frame thus locking the door.

A hexalobular, or star, headed machine screw controlled device made in accordance with this invention will provide an alternative control method to that of an ordinary cylinder key such as that used in most cylinder controlled dead locks.

### SUMMARY OF THE INVENTION

The hexalobular, or star, control of devices through a door thickness or through the width of a door frame, which door being part of a doorway as is the door frame, rather than the _{now} compromised standard cylinder lock used on most door locks, or other controllable means, consists of a hexalobular machine screw inserted to some required length into a correspondingly deep hole drilled through a door or door frame such that the distal hexalobular head of the machine screw can be accessed via a smaller drilled hole in line and concentric with the aforementioned by means of a modified hexalobular screwdriver, herein defined as a key from the outside of the door.

The primal end of the said machine screw, extending through the door or door frame, hence turns any device securely attached to it be it a lock bolt, or some other switch or push button device for controlling electronic equipment such as an alarm system or a closed circuit security camera.

An object of this invention is to provide an alternative means of controlling the operation of a lock bolt from the outside of a door as opposed to the standard cylinder lock key.

An object of this invention is to provide a means of controlling an electronic device from the outside of a door.

An object of this invention is to provide a means of controlling any mechanical device such as a dead lock latch from the outside of a door.

An object of this invention is to provide a means of coding the hexalobular head of a machine screw such that the permutation of entry methods through a door decreases the possibility of illegal entry.

An object of this invention is to provide a means of coding the hexalobular end of a modified screwdriver, herein defined as a key, such that the coding matches that of a hexalobular headed machine screw herein employed as a control means for various additional devices.

The above stated and other objects and advantages of the invention will become apparent from the following description when taken with the accompanying drawings and descriptions. It will be understood, however, that the drawings are for purposes of illustration and are not to be construed as defining the scope or limits of the invention, references being had for the latter purposes to the claims appended hereto.

### BRIEF DESCRIPTION OF THE DRAWINGS

In the drawings wherein the reference characters denote like parts in the several views.

FIG. 1. shows an exploded view of the basic components of a typical installation.

FIG. 2. shows a plan view of a door installation wherein a lock assembly is demonstrated.

FIG. 3. shows an angled view of a frame lock installations wherein a frame based lock bolt extends from the frame to the door

FIG. 4. Shows a basic assembly controlling an electric switch.

FIG. 5. shows a basic assembly controlling a mechanical arrangement used in a dead lock latch.

FIG. 6. shows a standard female head of a hexalobular machine screw.

FIG. 7. shows the modified head of a hexalobular machine screw in which an interstice between the lobes has been punched closed.

FIG. 8. shows a modified hexalobular screwdriver, used as a key which fits the modified head of the machine screw shown in FIG. 7.

### DESCRIPTION OF THE PREFERRED EMBODIMENT

Figure one shows a section of a door (13) being part of a designated doorway, through which a small pilot hole (2) is drilled. A second larger hole(3) id thence drilled concentric to the smaller pilot hole (2) such that when a hexalobular, or star headed (1) machine screw (4) is slid into the larger drilled hole(3) its hexalobular head (1) is accessible via the small hole (2) which hole (2) is located on the outside of the door (13). A spacer(5) slid over the machine screw(4) diameter bears upon the distal underside if the machine screw head (1) and its primal end upon the underside of a base plate (8). When the base plate(8) is henceforth screwed to the inside surface of the door(13) by means of wood screws (6) and (7) the machine screw (4) will Extend through a clearance hole (37) drilled through the base plate (8) such that a lock bolt (9) can be screwed on to the said machine screw (4) through threaded hole (11) in a manner that lock bolt (9) can be readily turned when the machine screw (4) is turned. An acorn nut (10) is thence screwed on to the thread of the protruding end of the machine screw (4) locking the lock bolt (9) on to the primal end of the machine screw (4)

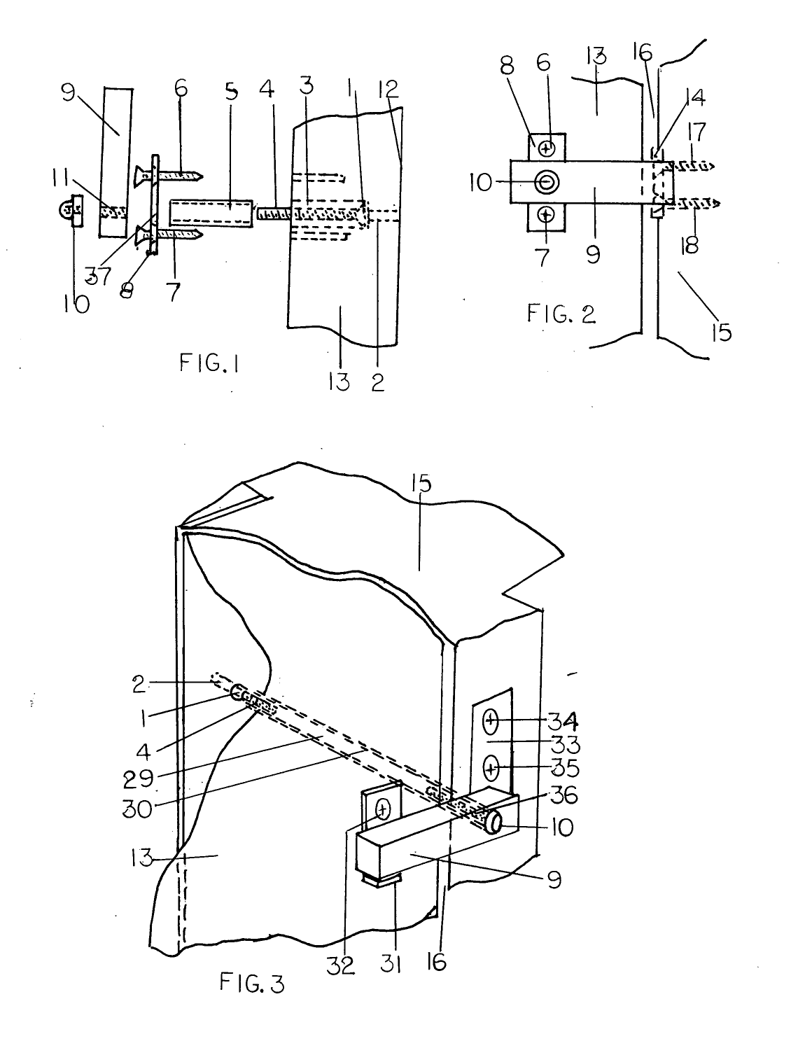

A modified hexalobular head screwdriver herein designated as a key whose head is shown in FIG. 8 inserted into the small hole (2) engages on the hexalobular machine screw head (1) thus causing the lock bolt (9) to turn into a locked or unlocked condition when the hexalobular screwdriver is turned. FIG. 2 shows that which is shown in FIG. 1 now assembled on a door (13) as viewed from the inside of the door. The lock bolt (9) pivoted at the machine screw (4) underneath the acorn nut (10) spans the door gap (16) and thence locks on to a hooked strike plate (14) which plate is screwed to the door frame (15) by means of the wood screws (17) and (18).

FIG. 3 shows a basically similar installation as shown in FIG. 2 except that the locking system is now mounted on a door frame (15) as opposed to a door, which assembly requires a larger spacer (29) which is threaded at each of its ends on its internal diameter. Machine screw (4) is screwed into the distal end of spacer (19) and is located such that its hexalobular head (1) is accessible via hole (2) at the distal end of the assembly. The primal end of the spacer (29) has a headless screw screwed into it such that its exposed threaded end can be screwed into the lock bolt (9) and thence locked into position by acorn nut (10). The lock bolt (9) spans the door gap (16) and is held in position by the angled strike plate (31) which is attached to the inside of the door (13) by means of the screw (32) and a second screw behind the bolt (9). The complete assembly is attached to the indoor side of the frame (15) by means of the base mounting plate (33) and wood screws (24) and (35).

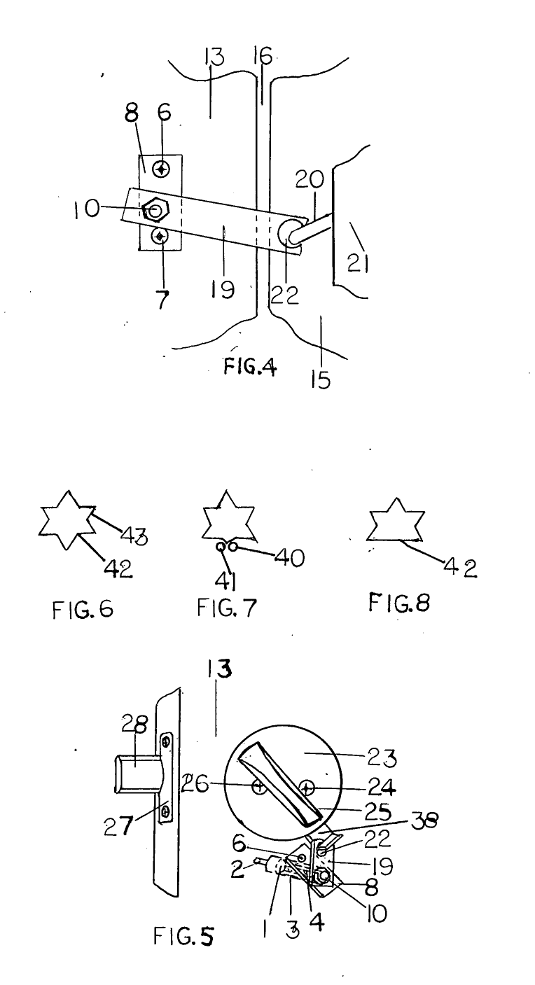

FIG. 4 shows an assembly of a further application of the basic, invention in which an electric toggle switch (20) is controlled. The assembly is attached to the indoor surface of the door as heretofore described such that the lever arm (19) held firmly in place by the aforesaid acorn nut (10) spans the door gap (16) and hence encircles the toggle switch arm (20) by means of the circular cutout(22).

FIG. 5 shows a complete assembly with its aspect to the existing dead lock (23) installation in which a mechanical slide plate (38), acting as a latch, is employed to double lock the dead lock (23) this said latch (38) being controlled from outside the door (13) by the insertion of a hexalobular headed modified key into hole (2) and thus engaging upon the hexalobular head (1) of machine screw (4) such that when the said machine screw (4) is turned the control plate (19), attached to the primal end of machine screw (4), and held firmly in place by acorn nut (10) will swivel pulling the latch slide plate (38) in or out of the existing lock housing thus preventing the dead bolt (28) from being opened by any means.

FIG. 6 shows a hexalobular design of a screwdriver head or a machine screw head. The lobes (43) of which there are six, hence the name hexalobular, generate six interstices (42).

FIG. 7 shows the modified hexalobular machine screw (4) head in which one of the interstices has been removed by punching on either side of the interstice at (40) and (41).

FIG. 8 shows the modified head of a hexalobular screwdriver in which one of the lobes has been removed by grinding such that it matches the coded head of the machine screw as shown in FIG. 7.

The above applications of the hexalobular coded head machine screw and screwdriver are shown to indicate the operational capability in expanding the permutations required to break the code of the through the door or through the frame, each being part of a doorway, which hexalobular control is the main theme of this invention as shown in the appended claims.

What is claimed is:

1. A locking device mounted on a door or door frame, which items being defined as a doorway, and which locking device consisting of a hexalobular headed metal shaft engaging upon a hexalobular female headed machine screw thus forming a keying device types of which said keying devices being such that when coupled to varied metal shafts and thence inserted into a hole drilled through the said door or said door frame their distal female heads are located within a short distance of the external or distal side of the door or door frame in a manner that that their distal female heads are accessible through a smaller hole drilled concentric to the aforementioned hole by means of the above described hexalobular headed metal shaft such that when this hexalobular headed shaft is engaged in its corresponding female counterparts in the said hexalobular headed machine screw and turned from the distal or outside of the door or door frame that that device which is attached to the primal or inside of the door or door frame so also turns these said attached devices which said devices comprise:
(a) A lock bolt screwed to the primal indoor threaded end of a hexalobular headed machine screw extending out from a door surface such that when the distal end of the said hexalobular machine screw is turned the said lock bolt so also turns thus extending, in a locking function across the door gap and hence locating into a hooked strike plate attached to the door frame being part of the doorway and thus locking the door.
(b) A locking assembly within which a long tube extending almost the depth of the door frame which has each ends internal diameter threaded such that a hexalobular headed machine screw screwed into its distal end and a headless screw screwed into its primal end such that a lock bolt can be screwed on to the opposite end of this headless screw and hence locked in place by an acorn nut such that when the hexalobular female head is engaged by a male hexalobular shaft, such as a modified hexalobular screwdriver, and thence turned the said lock bolt will so also turn correspondingly thus causing the lock bolt to span the gap between the door and the door frame and hence locate on an angled strike plate attached to the said door such that the door is locked to the frame.
(c) a slotted lock bolt which when controlled by a hexalobular mechanical means turns across a door gap and thence performs two functions the first of which is the engagement of the slotted end section of the said slotted bolt on a toggle switch or other appropriate control which switch controls some electronic or electric device and hence secondarily engages in a hooked strike plate attached to the associated door frame thus locking the door and so also controlling some other switch controlled device.
(d) a slotted metal plate which when controlled by a hexalobular control means and installed adjacent to an existing dead bolt lock which has a latching device attached such that they are contiguous and in a manner that when the hexalobular control means is turned so also does the slotted metal plate and hence the attached dead bolt latch to thus enter or retract from the dead bolt housing and so control the use of the dead bolt to gain entry into premises.
(e) a hexalobular control means which can be coded by blocking any one or any number of the interstices between the control lobes in the female section of the hexalobular control means thus blocking the use of any other hexalobular device which does not have a corresponding lobe removed from its male section of the hexalobular control means.
